(19) United States
(12) Patent Application Publication
(10) Pub. No.: US 2008/0203761 A1
(43) Pub. Date: Aug. 28, 2008

(54) Radiant heat barrier protected recreation vehicles and methodology for constructing same

(76) Inventor: Leland D. Smith, Reno, NV (US)

Correspondence Address: John D. Long, PATENT COUNSEL;LONG & CHYBIK, Suite 115, 1575 Delucchi Lane, Reno, NV, 89502, US

(21) Appl. No.: 11/712,852

(22) Filed: Feb. 28, 2007

(51) Int. Cl. B60J 10/00

(52) U.S. Cl. 296/156

(57) ABSTRACT

One possible embodiment of the invention could be a recreation or recreational vehicle, either self-powered or towed, whose structure components and the like could substantially define an interior living space (e.g., walls, ceiling, floor, and the like) wherein the structural components could be formed from interior components generally sandwiched between exterior components. A suitable radiant heat barrier could then be applied to one or more portions to the interior components or to an interior surface of the exterior components. In another version of this embodiment wherein the recreation vehicle has one or more flexible sides, the radiant heat barrier could be generally incorporated into the flexible sides as part of a laminate forming the flexible sides.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention may relate to recreational vehicles and in particular, to the incorporation of a radiant heat barrier into structures that may define the interior living spaces of such vehicles.

### BACKGROUND

Recreational or recreation vehicles (RVs) typically provide their users with some form of generally enclosed interior living space (e.g., a movable living space) that may have one or more comforts and amenities of home while traveling. The enclosed interior living spaces of RVs are generally mounted on wheels (thus generally including both motorized vehicles and non-motorized vehicles.) Motorized RVs could include, but not necessarily be limited to, motor coaches, motor homes, modified motor vehicles (e.g., vans that have been modified to include living amenities) and the like. Non-motorized RVs could include, but not necessarily be limited to, towed vehicles such as a fifth wheel trailer, mobile home, travel trailer, sport utility trailer, pickup bed camper, camper, trailer, vacation trailer, tent trailer, and the like.

The demand for such RVs is generally expected to increase significantly as the baby boomer generation, generally largest and wealthiest generation in the history of the United States to date, ages and begins to approach retirement during the next twenty years. As this generation retires from work and family life, its retirees will generally have much more time and money to invest towards RVs as a means to satisfy their desires for leisure and travel.

One of the amenities and comforts that may be provided by RVs is the shielding of its occupant(s) inside the RV from the environment outside the RV. This factor becomes very important for older occupants of the baby boomer generation, who as a matter of age, may have greater sensitivities relating to changes in a vehicle's internal environment as caused by the effect of exterior environment. Generally, this ability of this shielding may be related to the size and construction of the RV as well as the various physical systems employed by the RV. For example, a smaller RV such as a tent camper may only protect its occupant(s) from wind, rain, sun and the like but does not protect them from the temperature or humidity of the outside environment. The smaller RV may lack insulating capabilities in its structure and may not provide for heating/cooling/humidity control systems. If it is freezing and wet outside the tent camper, it generally is most likely going to be freezing and damp inside the tent camper. As the size of the RV increases (along with a correlating increase in its cost), the RV may incorporate additional features and amenities, which may provide better control (and comfort) regarding the RV's internal environment. This increase in shielding capability may be a result of the larger RVs construction, which may allow for the use of more solid and thicker walls and roofs that may resist the movement of heat in and out of the RV as influenced by the external environment. Additionally, the use of thermal insulation in conjunction with or integrated into the RV's structures may assist in slowing down the movement of heat through the RV structure. In some of the larger RVs, there may be additional systems such as HVAC (heating, ventilation air-condition), which may provide greater internal environmental controls to resist the undesired influence of the outside environment. In contrast, smaller RVs may lack sufficient construction, insulation, and HVAC systems to regulate effectively and comfortably the external environmental influences. The tent camper could have for its walls, insulated, flexible, thin fabric sheets to allow the vehicle to go into a compact state for storage or travel. The HVAC system of the tent camper could be limited to screens in the flexible tent walls to allow breezes in and to keep bugs out.

Even with the larger RVs, there may be limitations to usage of environmental control systems. Environmental control systems can be expensive to purchase and install; be expensive to run (e.g. high costs of fossil fuel to run them); require a sizable vehicle structure to support them; and may require additional support systems (e.g., electrical power systems) to run. Such complexities and costs may altogether prevent any usage of such devices in smaller RVs.

Similarly, thermal insulation for RVs (e.g., fiberglass panels, foam insulation, spray in insulation, etc) may have several limitations as well. Such thermal insulation may generally be found in the structure components (e.g., walls, roof, floor, etc.) and as such made as a part of the structural components or located within a cavity of the structural components. For example, fiberglass panels may be used for thermal insulation as well as being used as an outer layer of a structural component. Foam insulation, sheets, panel, blown in types, due to their delicate nature, could be placed inside the cavity located within the RV's structural components.

There may be an overall limitation of thermal insulation in that it only slows the transmission of heat (e.g., infrared radiation) but it does not reflect heat back. Generally, heat generally moves toward the cold so the issue becomes how to help keep heat substantially inside the RV when it is cold out and how to help keep the heat substantially outside of the RV when it is hot out and not just slow down the transmission of heat in and out of the RV.

Generally, there could be three ways in which heat may travel from a warm area to a cold area: conduction, which is generally a direct heat flow through a solid objects like a wall or ceiling; convection, which is generally a heat movement through air, occurring when the air is warmed (e.g., warm air expands, becomes less dense, and rises into colder air); and radiation, which is generally the movement of heat rays across air spaces from one warm object to another cooler object (e.g., many objects, such as our bodies may give off radiant heat). Radiant heat generally travels in a straight line away from the hot surface. As the radiant heat (e.g., as a wave of energy) encounters anything solid, the heat generally warms the object. Although, the RV may incorporate thermal insulation to handle generally direct heat flow and forms of HVAC for controlling convection, these heat control means may generally lack the capability of reflecting radiant heat in or out of the RV's living space.

What is needed therefore an apparatus, which can be easily and cost effectively applied to RVs, both large and small, to generally reflect radiant heat and supplement whatever thermal insulation and HVAC systems a RV may have in particular circumstance.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to generally reflect radiant heat relative to a recreational or recreation vehicle (RV) interior living space;

provide a thin layer reflective heat barrier (i.e., RHB), which may be applied to flat and curved structural components of an RV;

provide a RHB whose effective thickness does not preclude it from being incorporated in the RV's structural components;

provide a reflective heat barrier that could be installed in a cavity in a structural component of a RV;

provide a reflective heat barrier that could be incorporated as a laminate relative to one or more of a RV's structural components;

the ability to incorporate a RHB into the doors and window shades of an RV;

provide additional insulation shielding capability to the RVs in general; and

provide the walls, floor, and roof of an RV with capability to reflect the movement of radiant heat.

These and other advantages may be realized by reference to the remaining portions of the specification, claims, and abstract.

### BRIEF DESCRIPTION OF ONE EMBODIMENT OF THE PRESENT INVENTION

One possible embodiment could be a recreational or recreation vehicle (RV) comprising a carriage assembly having a plurality of wheels; a plurality of structural components mounted on a carriage assembly, wherein the structural components by themselves or in conjunction with the carriage assembly are arranged to define an interior living space; and have a radiant heat barrier that is integral to at least one of the structural components.

Another version of one possible embodiment could be a method of insulating a RV comprising of the following steps but not necessarily in the order shown; applying a radiant heat barrier to at least a portion of a structural component of a recreation vehicle that is used to define the interior living space; and applying a fastening means to hold the radiant heat barrier onto the portion of the structural component of the recreation vehicle.

Another version of one possible embodiment could comprise a carriage assembly means for moving a movable interior living space; a structural component means for further defining movable interior living space on the carriage assembly means; and a reflection means for reflecting radiant heat by the structural component means relative to the moveable interior living space.

The above-description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1A is substantially a cutaway perspective view of one embodiment of the invention showing a larger recreational or recreation vehicle (RV) with the locations of a radiant heat barrier.

FIG. 1B is substantially a floor plan view of a larger RV of the present invention.

FIG. 2 is substantially a cutaway perspective view of one embodiment of the present invention showing a smaller RV with the locations of a radiant heat barrier.

FIG. 3 is substantially a cutaway perspective view of one embodiment of the present invention showing a larger RV with the locations of a radiant heat barrier for a roof cap, a roof, and a wall.

FIG. 3A is substantially a cutaway perspective view of another embodiment of the present invention showing a larger RV with the locations of a radiant heat barrier for a roof cap, a roof, and a wall.

FIG. 4 is substantially a cutaway perspective view of one embodiment of the present invention showing a larger recreation vehicle (RV) with the locations of a radiant heat barrier for a floor.

FIG. 4A is substantially a cutaway perspective view of one embodiment of the present invention showing a larger RV with the locations of a radiant heat barrier for a floor.

FIG. 4B is substantially a cutaway perspective view of one embodiment of the present invention showing a RV with the locations of a radiant heat barrier for a floor.

FIG. 4C is substantially a cutaway perspective view of one embodiment of the present invention showing a larger RV with the locations of a radiant heat barrier for the floor.

FIG. 5 is substantially a cutaway perspective view of one embodiment of the present invention showing a smaller RV with the locations of a radiant heat barrier for the flexible parts of the RV.

FIG. 6 is substantially a cutaway perspective view of a shade for a RV window showing the locations of shade's radiant heat barrier.

FIG. 7 is substantially a flowchart showing a possible process for employing a RV with a radiant heat barrier.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

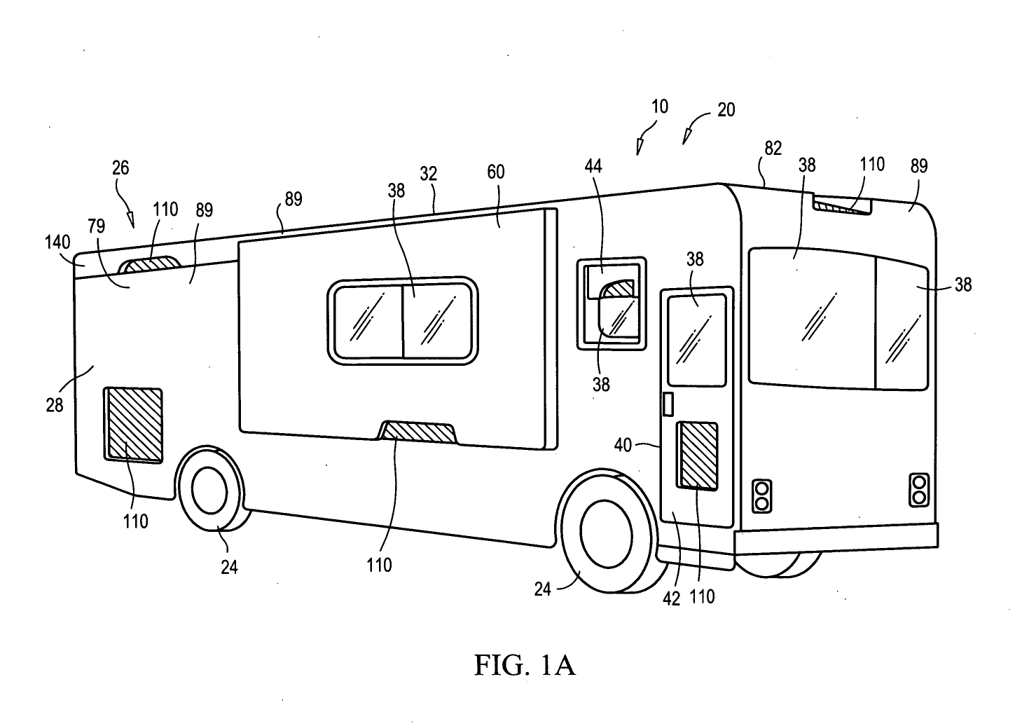

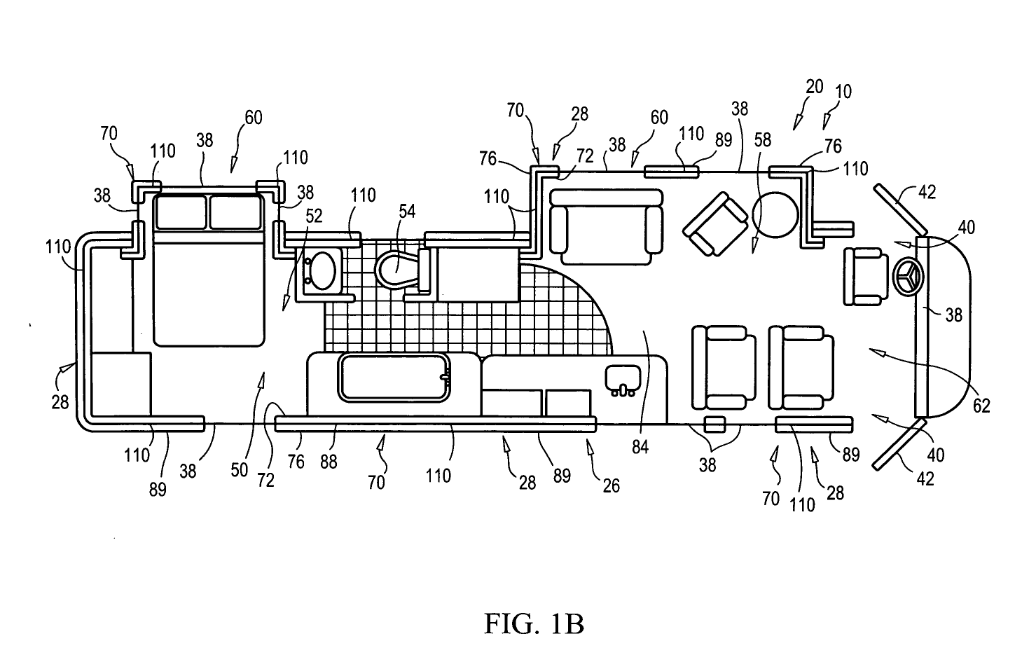

As generally shown in FIGS. 1A & 1B, one possible embodiment of the present invention 10 could be comprised of a radiant heat barrier 110 incorporated into a recreational or recreation vehicle (RV) 20. The RV 20 could be comprised of a carriage assemble 22 to which a set of wheels 24 are moveably affixed to provide for its movement over the ground. In motor-powered versions of the RV 20, a power train (not shown) could be attached to one or more of the wheels 24 to enable the RV with self-propulsion. The construction of some of the larger powered RVs could provide for a body comprised of joined or bonded structural components 70, in a manner known, defining the vehicle's movable interior living space 50 (e.g., generally forming the walls 28, ceiling 30, and floor 36). This body 26 could then be attached to a separate carriage assembly 22 (e.g., chassis) to form generally the RV 20. In other types of larger powered RVs 20, the RV 20 could be of a monocoque construction in a manner known to the art, wherein the structural components 70 may be integrated directly with the carriage assembly 22 to define the interior living space 50 (e.g., the structural components 70 generally form the walls 28 and ceiling 30/roof 32. The top of the carriage assembly 22 could generally be used to define a floor 36 for the interior living space 50). In various versions of the RVs, the structural components 70 could also be constructed and assembled to provide egress/exit (e.g. doorways 42) and allow light passage (e.g., windows 38) into the interior living space 50.

The larger motorized RV 20 could be designed and built so that its construction, insulation, environmental systems and alike allow its occupants to travel and live in comfort although the environment outside the RV 20 may be adverse or at least substantially different from the environment of the interior 50 of the RV 20). In one aspect, the use of environmental systems (e.g. powered HVAC) (not shown) could be used as active means for controlling the interior environment of the RV 20. In another aspect, insulation and other construction elements could be used as a passive means for also influencing the interior environment against the effects of the exterior environment. This passive means should also be appreciated for its ability to contribute in increasing the RV's energy efficiency by decreasing the need to run the active environmental systems of the RV 20 thus generally reducing consumption of fossil fuel.

The walls 28 of the RV 20 could be built to contain at least one vehicle access to the interior living space 50 (e.g. doorway 40 and respective movably attached door 42) egress and exit. For the larger RV 20, its living space interior 50 could be subdivided into a variety of living areas such as sleeping quarters 52, toilet 54, dining area 56, living room 58, and the like. Additionally, the larger RVs 20 could be built with an expandable slide out section 60 movably mounted relative to a sidewall. That section 60 may be expanded when the RV 20 could be at rest to increase the size of its interior living space 50. The front section of the RV 20 could be designated passenger compartment area 62 where during travel the occupants could sit and the driver could operate the motorized RV 20. It should be appreciated that the illustrated layout of one motorized RV 20 is generally a merely an illustrative embodiment and that multiple other designs and RV types could be used and still considered well within the purview of the invention.

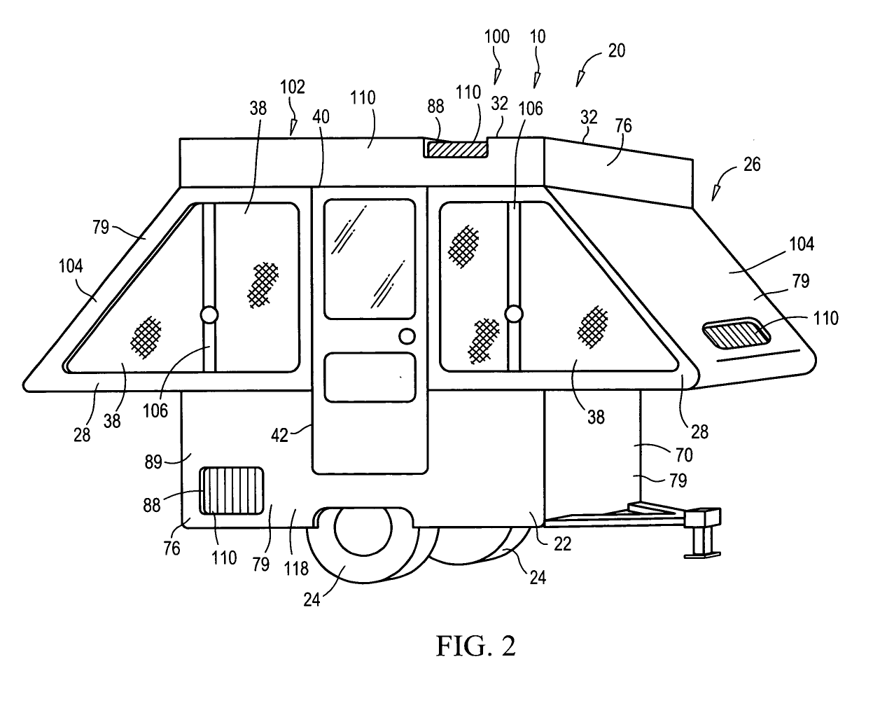

As substantially shown in FIG. 2, one example of a non-motorized RV 20, could be a tent camper 100 that generally features a carriage assembly 22 to which wheels 24 are mounted to allow generally for travel over the ground. Generally, there is no motor connected to the wheels 24 to provide a means of self-propulsion for this type of RV 20. Attached to carriage assembly 22 in monocoque fashion or separate body-chassis fashion, structural components 70 (e.g., in combination with the carriage assembly 22) can generally define a movable interior living space 50 for use by the occupants of the RV 20. A tent camper 100 could further have a rigid top 102 that could be substantially connected to points on the top of an expandable metal framework 106. The bottom of the framework 106 could be connected to various points located on the topside of the carriage assembly 22. Generally connected to the bottom side of the rigid top 102 and the top side of carriage assembly 22 may be the extendable flexible sides 104 (e.g. the tent structure) that can be pulled out of the compacted state when the framework 106 is generally expanded to lift the rigid top 102 up and away from the carriage assembly 22. In the expanded state, the tent camper 100 could generally be ready for occupancy. In the compacted state with flexible sides 104 (e.g. walls 28) generally stored, the tent camper 100 could generally be ready for travel. It should be appreciated that the illustrated layout of one non-motorized RV 20 is generally merely an illustrative embodiment and that multiple other designs and RV types could be used and still considered well within the purview of the invention.

The radiant heat barrier (RHB) 110, which generally does not provide a significant amount of thermal insulation, may be combined with thermal insulation for increased insulation capacity and energy efficiency (e.g., reducing need for and use of powered HVAC systems of the RV). RHBs 110 generally reduce heat gains without the need for increasing wall thickness in order to accommodate bulky insulation.

A radiant heat barrier (RHB) 110 as used by the invention could come in various forms, including but not necessarily limited to: reflective film (e.g., foil) 112, reflective paint 114, and reflective chips 116 (which may be mixed with loose-fill insulation) and the like. The RHB 110 is generally constructed to have one or more layers of reflective material (e.g., aluminum, but other materials such as gold could work as well). In the cases of RHB-based on reflective film 112, reflective chips-based RHB 116, and the like (e.g., reflective paint-based RHB 114) the reflective layer could be bonded to one or more sides of some form of substrate. This substrate could include but not necessarily be limited to materials such as kraft paper, plastic films, cardboard, plywood sheathing, and air infiltration barrier material and the like. The substrate can be either rigid (plywood sheathing) or flexible (plastic film). Some substrates could be further fiber reinforced or the like to increase the durability and ease of handling of the RHB 110.

It is believed by some that the orientation of the RHB 110 could also be important for optimum usage of the device. Some skilled in the art believe that if a one-sided heat radiant barrier 110 is laid over insulation with the reflective side of the RHB 110 facing down and touching insulation, the RHB 110 could possibly lose some of its effectiveness in reducing heating and cooling loads.

If the RHB 110 only has a reflective surface on one side, then the single reflective side of the RHB 110 should generally be separated (have air contact mostly) from other conductive surfaces so that heat caught by the RHB 110 is not directly transmitted back to the other surface to directly heat that surface. That space can be as small as ¾″ but it should face a foil surface if possible. Some RHB 110 in some applications may act as a vapor barrier, so that foil or film versions of the barrier should incorporate perforations to allow built up condensation or other moisture to pass through.

The effectiveness of a radiant heat barrier 110 could be judged as a combination of several factors including but not necessarily limited to emissivity, reflectively, and angle of heat striking the barrier. Emissivity (or emittance) could be described as the ratio of the radiant energy (heat) leaving (being emitted by) a surface to that of a black body at the same temperature and with the same area. It is generally expressed as a number between 0 and 1 (e.g., the higher the number, generally the greater the emitted radiation.)

Reflectivity (also called the “reflectance”) is substantially a measure of how much radiant heat is reflected by a material. The reflectivity may also be designated as a number between 0 and 1 (e.g., sometimes, it is given as a percentage, and then it is between 0 and 100%). The two factors, reflectively and emissivity for a generally effective RHB 110 could be seen as having an inverse proportion relationship (e.g., a high reflectivity and a low emissivity). Effective radiant heat barriers could substantially have a low emittance (0.1 or less) and high reflectance (0.9 or more).

Of these factors, the angle of the heat wave (e.g., the angle of the heat wave when it strikes the RHB surface) may have a significant influence on how well a reflective surface acts as a thermal reflector. In some RHB applications, it has generally been found that if the radiant heat wave hits the RHB 110 at right angle (perpendicular) to the barrier's orientation, this could provide for efficient reflection of the radiant heat by the RHB 110.

Additionally, the greater the temperature difference between the sides of the radiant barrier material (e.g., between inside and outside environments) the more efficiently the RHB may work.

As denoted above, the structural components 70 generally in conjunction with or without the carriage assembly 22 could substantially define the interior living space 50 for the RV 20. The structural components 70 of the RV 20 (e.g. a motor coach) could be comprised of interior components 72 and exterior components 76 that when joined could form a cavity 88 for holding the RHB 110, thermal insulation and the like.

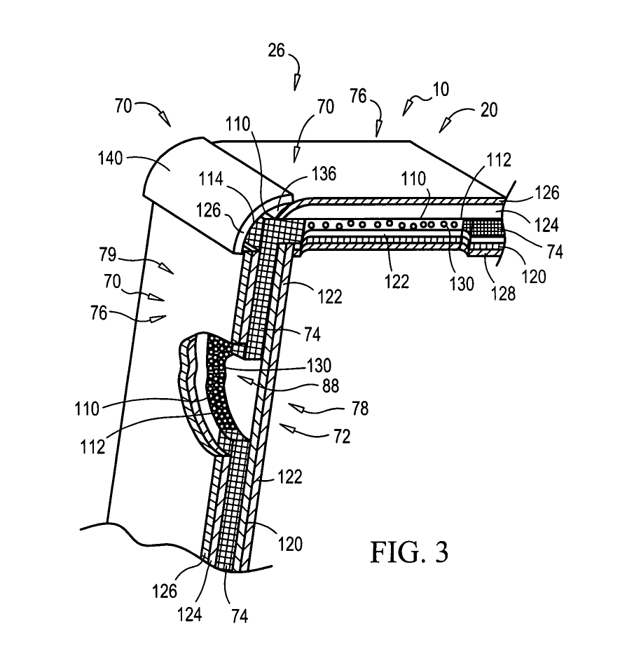

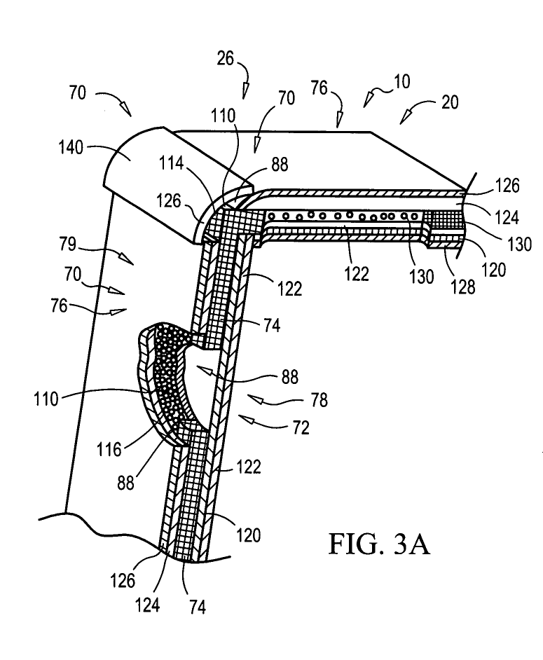

As substantially shown in FIGS. 3 and 3A, the wall 28, in one possible embodiment, could have an interior component 72 of a metal framework 74 formed by a grid work of metal tubing or the like. The exterior components 76 could be the inside wall section 78 and the outside wall section 79. The inside wall section 78 could be composed of layers of ¼ medium-density fiberboard (MDF) 120, 26 gauge galvanized metal sheet 122, and the like, while the outside wall section 79 could be composed of layers of ⅛ luan plywood 124 and ¼ inch fiberglass 126. When the exterior components 76 (e.g., the wall sections, inside 78 and outside 79) are placed upon interior components 72 (e.g., the metal framework 74) to form generally the structural components 70 for the wall 28, this could form a cavity 88 in the wall 28 proximate to and at least partially defined by the metal framework 74. In this cavity 88, could be placed a cut sheet of foam insulation 130 as well as the RHB 110. In one instance, the RHB 110 is directly attached to the sheet of foam insulation 130 and the foam insulation 130 could be secured and placed so that the reflective side of the RHB 110 generally does not substantially contact the corresponding exterior components 76. In another instance, at least one side of the foam insulation 130 or one side of the corresponding exterior component 76 could be sprayed with RHB paint 114. In yet another instance, RHB chips 116 could be blown into the cavity 88.

Additionally, the foam insulation (e.g. foam sheet) 130 could be appropriately trimmed or manufactured so that one side of the foam insulation sheet 130 substantially features a depression 132 surrounded by raised edges 134. The RHB 110 (e.g. film form) could be attached to the depression 132 while the raised edges 134 substantially contact the surrounding exterior components 76 to keep an air space 136 between the reflective surface of the RHB 110 and corresponding relevant surfaces of the exterior components 76.

In yet another instance, a RHB film(s) 112 could be laid over the outside of the wall's metal framework 74. Over this RHB film 112 could be applied the exterior components 76, which could then be fastened to the metal framework 74 (e.g., by piercing at certain points the RHB film 112 to reach the framework 74.) Sheets of RHB film 112 could then be used to cover large portions of the relevant framework 74. The edges of the RHB film 112 could overlap when covering the framework 75 but would not be always necessary. The sheets of RHB film 112 could be flexible enough to bend around and accommodate the curved (e.g., non-planar) portions of the framework 75. The RHB film 112 could be attached by various other fastening means 118 such as placing a cover 89 over the RHB film 112, use of adhesive, vacuum suction, fasteners, and the like.

Other versions of the RHB 110 could be installed and secured with suitable means and method known in the art and still be considered within the scope of the invention.

The roof 32 of the RV 20 could be similarly formed by structural components 70 composed of interior components 72 and exterior components 76. The structural component 70 for the roof 32 could again be a portion of the metal framework 74 surrounded by exterior components 76 (e.g., comprising of an inside roof section 80 and an outside roof section 82.) The outside roof section 80 in one embodiment could be comprised of layers of fiberglass 126 and luan plywood 124 while the outside roof section 82 could be comprised of layers of 26 gauge galvanized metal 122, MDF 120, and padded vinyl 128. When the inside roof section 80 and an outside roof section 82 are placed upon the interior component 72 (e.g., metal framework 74), the resulting spacing between the open framework 74 could generally define cavities 88 into which RHB 110 can be introduced along with or instead of the foam insulation 130 that would normally reside in the cavity 88 in the manner described-above for the RV walls 28.

As described for the RV wall 28, a RHB film(s) 112 could be laid over the outside of the roof's metal framework 74. Over this RHB film 112 could be applied the exterior components 76, which could then be fastened to the metal framework 74 (e.g., by piercing at certain points the RHB film 112 to reach the framework 74.) Sheets of RHB film 112 could then be used to cover large portions of relevant framework 74. The edges of the RHB film 112 could overlap but this would not be always necessary. The sheets of RHB film 112 could be attached by various fastening means 118 such as placing a cover 89 over it, use of adhesive, vacuum suction. Other versions of the RHB 110 could be installed and secured with suitable fastening means 118 relative to the roof 32 with materials and methods known in the art and still be considered within the scope of the invention.

Where the roof 32 and wall 28 join could be connected by a roof cap 140. The roof cap 140 could be composed of fiberglass, metal or of other appropriate material, and be shaped to have a generally C-cross-section. The connection caused by the roof cap 140 to the edges of the outside roof sections 82 and outside wall sections 79 could further provide another cavity 88 to which RHB 110 could be applied. In such instances, RHB reflective paint 114 or RHB film 112 could be applied to the underside of the roof cap 140 in a manner known in the art. Other types of RHB 110 and various fastening means 118 could be employed. This could include but not necessarily be limited to blowing in RHB chips 116 into the cavities 88.

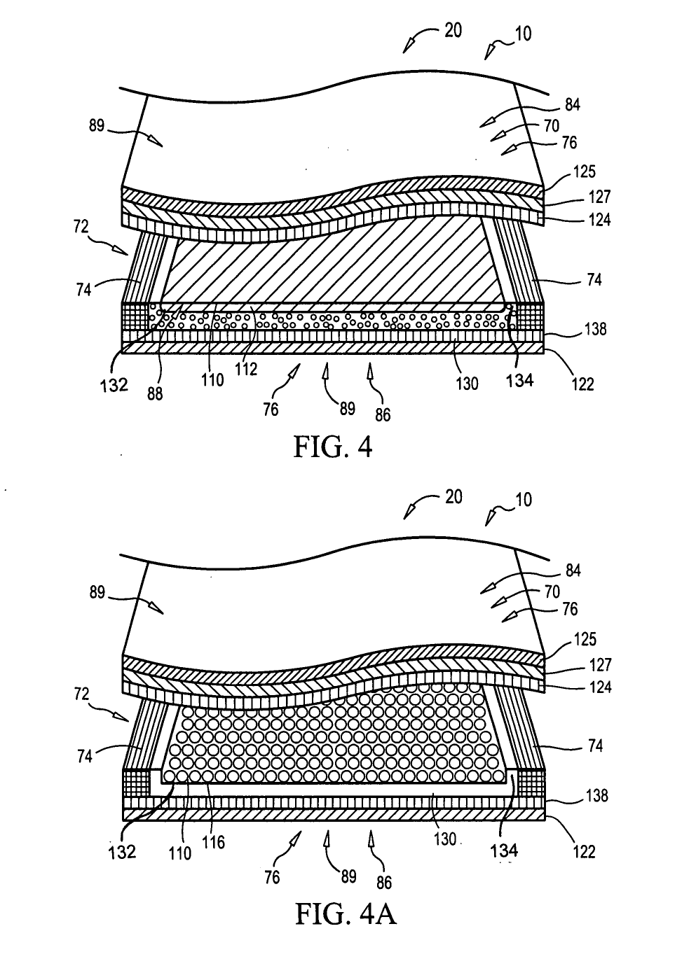

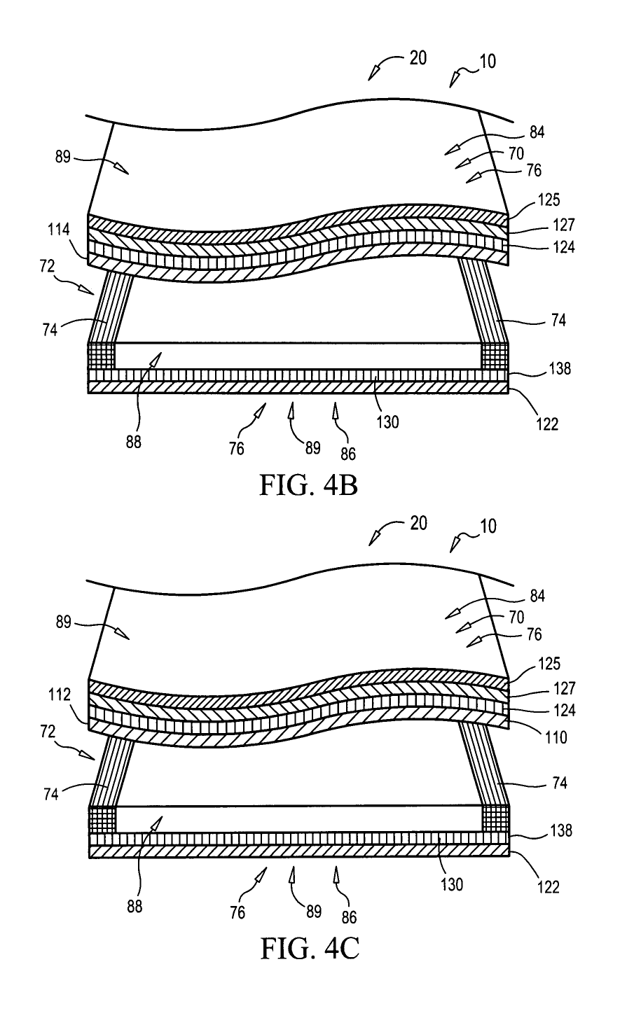

As shown in FIGS. 4, 4A, 4B, and 4C, the floor 36 of an RV 20 could also be comprised of the carriage assembly 22, the structural components 70, or a combination of the two. The floor 36, as described for the roof 32 and walls 28, could also be comprised of interior components 72 and external components 76. The interior components 72 could be the open metal framework 74 that provides the basic structural support for the RV 20. The exterior components 72 could be an inside floor section 84 and an outside floor section 86. The inside floor section 84 could in one embodiment be comprised of layers of carpet 125, carpet padding 126, plywood sheaths 124. In one embodiment, the outside floor section 82 could be comprised of layers of galvanized sheet metal 122 and sealer 138. When the inside flooring section 84 and outside flooring section 86 are connected to the open metal framework 74, cavities 88 could formed between the metal members of the framework 74. In these cavities 88 could be inserted the RHB 110 as well as the respective thermal foam 130 insulation in the manner described above for the wall 28 and roof 32.

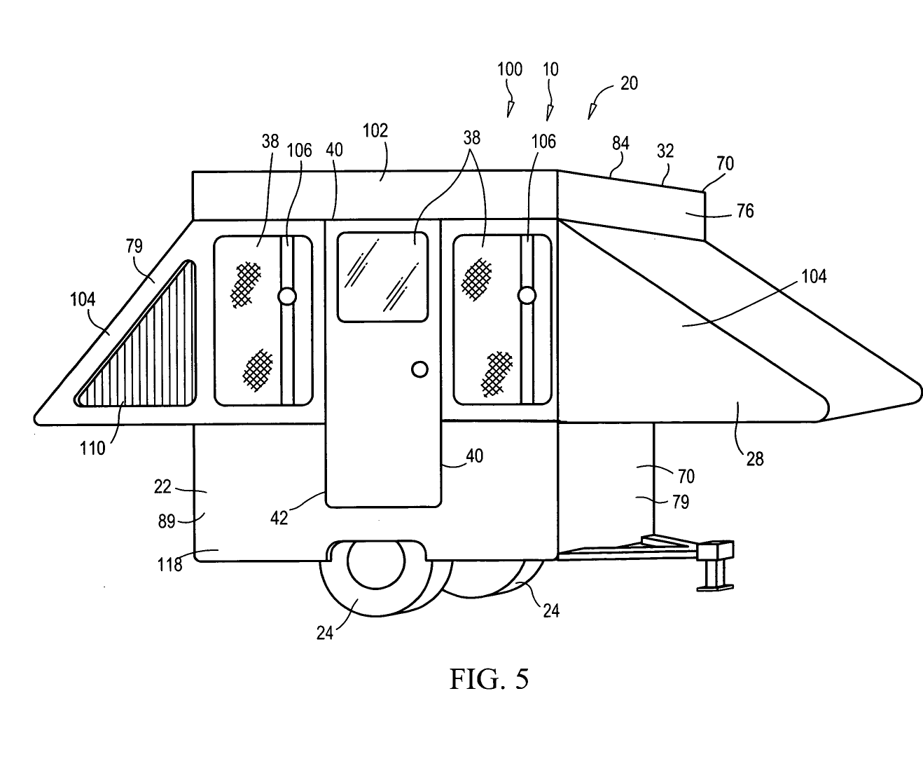

As shown in FIG. 5, the tent camper 100 could incorporate the RHB 110 in a similar manner as described above for the tent camper's non-flexible elements (e.g., for the carriage assembly 22 and rigid top 102). Additionally, the reflective paint or film forms of the RHB 110 could be applied to the flexible sides (e.g., tent walls) 104 of the tent camper 100. In this manner, the film form of the RHB 110 could be incorporated with the flexible fabric sides 104 as a laminate. The substrate backing of the RHB 110 could be affixed to the inner side of the flexible side 104 through adhesive while the foil side of the RHB 110, in at least one embodiment, could form the interior exposed side of the flexible tent wall or side 104 The flexibility of the RHB 110 would allow the flexible side 104 (including tent wall doors and the like) to retain its desired flexibility to allow these structures to be folded and expanded as needed for the tent camper operations operation.

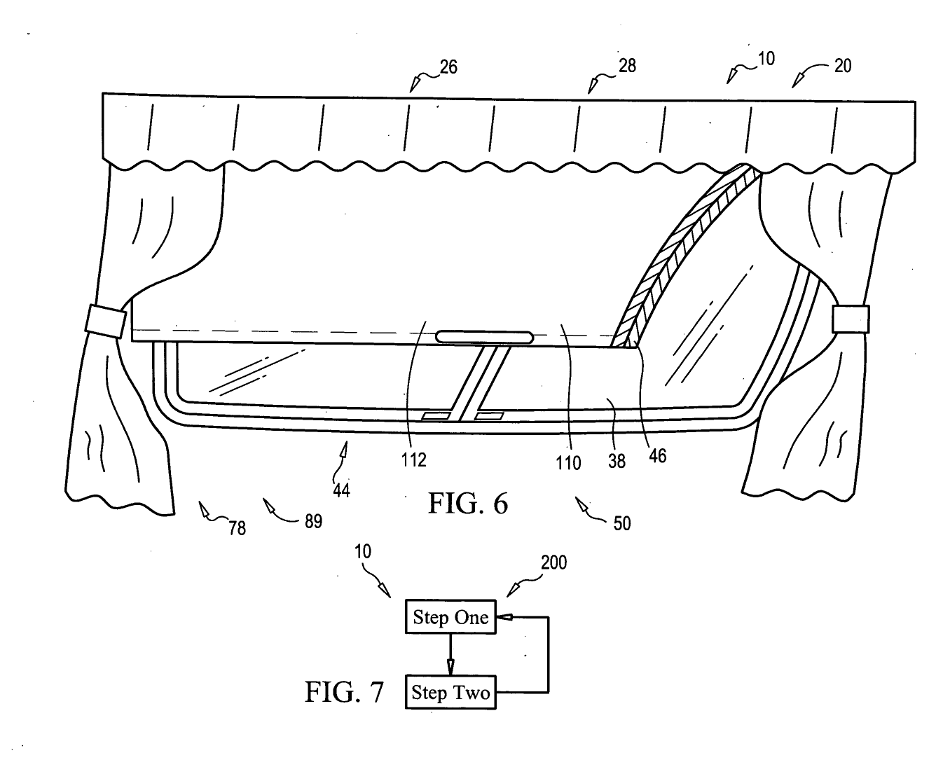

As shown in FIG. 6, the RV 20 that has window shades 44 (e.g., flexible coverings 46 for its windows such as the type that may be retractably be installed into the exterior components 76) could utilize the above methodology for the fabric of the flexible sides 104 to incorporate a RHB 110 into the window shade 44.

In one or more of the above-described embodiments or other embodiments, the invention 10 could use a paint form of the RHB 110 that could have a binder in the paint, which may be used as a fastening means 118 to secure the RHB 110 to structural component 70 or the carriage assembly 22. The RHB 110 in film form or the like could rely upon a suitable adhesive known in the art as a fastening means 118 to affix properly the RHB 110 to the structural components 70 or carriage assembly 22. The RHB 110 in chip form or plywood sheath substrate form and the like could use a cover 89 (e.g. the exterior components 76) as a fastening means 118 to hold the RHB 110 in place relative to the structural components 70 or to the carriage assembly 22.

As substantially shown in FIG. 7, a method or process 200 of employing a RHB 110 in an RV 20 could start with the first step of selecting a location within the RV 20 to place the RHB 110. This portion of the process could include providing a cavity 88 that is internal to a structural component 70 of the RV; identifying a flexible tent fabric or window shade fabric to which the RHB 110 could be affixed, or identifying an interior component 72 to which the RHB (e.g., a film RHB) could be externally applied. Once step one is substantially completed, the process 200 could move to step two, integrating the RHB 110.

At step two, integrating the RHB 110, the fastening means 118 could be attached to the fabric type structure of the RV 20 to which the RHB 110 is then integrated (e.g., spraying the adhesive onto the tent fabric, window shade fabric and then applying the RHB 110 to it thus forming a laminate). It could also call for inserting the RHB 110 (e.g. film form) into the cavity 88 and then sealing up the cavity 88 with exterior component 76. It could also call for having only a small opening into the cavity 88 into which the RHB chips 116 could be blown into and then be sealed. At the substantial completion of step two, the process 200 could repeat to step one.

### CONCLUSION

As generally described above, the invention may provide for a recreation vehicle whose construction incorporated a radiant heat barrier for the overall protection of the movable interior living space found within the vehicle's construction to easily provide significant insulation benefits.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

1. A recreational vehicle comprising:
(A) a carriage assembly having a plurality of wheels;
(B) a plurality of structural components mounted to a carriage assembly, wherein the structural components with the carriage assembly are arranged to define an interior living space; and
(C) a radiant heat barrier that is integral to at least a portion of one or more structural components or a portion of the carriage assembly used to define the interior living space.

2. A recreation vehicle of claim 1 wherein one or more structural enclosures could define walls, roof, and floor of the recreational vehicle, one or more of the walls, ceiling, roof, could incorporate a radiant heat barrier.

3. A recreational vehicle of claim 1 wherein the structural components comprise of an internal structural component sandwiched between exterior structural components, wherein the radiant heat barrier is located between the external component and internal components.

4. A recreational vehicle of claim 3 wherein the radiant heat barrier is located in a cavity formed by the external and internal components.

5. A recreational vehicle of claim 1 further comprising a fastening means to hold the radiant heat barrier in place relative to its structural component.

6. A recreational vehicle of claim 1 wherein the carriage assembly incorporates a radiant heat barrier to insulate the floor relating to the living space.

7. A recreational vehicle of claim 1 further comprising movable flexible shades incorporating a radiant heat barrier into its structure used for covering window spaces defined by the structural components.

8. A recreation vehicle of claim 1 further comprises one or more doors allowing access into the living space, the doors incorporating a radiant heat barrier into their structure.

9. A recreational vehicle of claim 1 further comprising a radiant heat barrier that is integrated into one or more of the structural components as a laminate.

10. (canceled)

11. (canceled)

12. (canceled)

13. (canceled)

14. (canceled)

15. (canceled)

16. (canceled)

17. (canceled)

18. (canceled)

19. (canceled)

20. (canceled)
